(19) United States
(12) Patent Application Publication
(10) Pub. No.: US 2012/0092234 A1
(43) Pub. Date: Apr. 19, 2012

(54) RECONFIGURABLE MULTIPLE-PLANE COMPUTER DISPLAY SYSTEM

(75) Inventors: David Ethan Trooskin-Zoller, Seattle, WA (US); Sven Pleyer, Woodinville, WA (US); Jonathan C. Cluts, Sammamish, WA (US); Johnny H. Lee, Sammamish, WA (US); David William Baumert, Sammamish, WA (US)

(73) Assignee: Microsoft Corporation, Redmond, WA (US)

(21) Appl. No.: 12/904,051

(22) Filed: Oct. 13, 2010

(51) Int. Cl. G09G 5/00

(52) U.S. Cl. 345/1.3

(57) ABSTRACT

A reconfigurable multiple-plane computer display system and method for repositioning computer displays with respect to each other. Embodiments of the system and method include using at least two computer displays that move relative to each other and are anchored in the same data space. Some displays may be fixed, but at least one of the displays is movable relative to other displays in the system. The displays are anchored to each other in data space, meaning that each display shows interesting data that is somehow tied or related to the information being displayed on the other displays. Embodiments of the system and method include displays that may be capable of actively displaying information on it own (active) or that has no way of displaying information on its own (passive). In addition, a display may include a positioning device to sense its location and display data based on that location.

### BACKGROUND

Many computer displays generally are limited to a single plane, such as a vertical monitor or a horizontal surface. Advanced displays such as those used in the Cave Automated Virtual Environment (CAVE®), which is a registered trademark of the University of Illinois Board of Trustees, are in more than one plane but are fixed with respect to each other. In other words, the displays cannot be moved relative to each other. This also is generally true for other multiple-monitor software that provides room and cockpit-like simulations.

Another type of display system uses a secondary passive display (such as a sheet of acetate) placed over the top of a primary projection display. In these types of systems, the secondary display (the sheet of acetate) does move relative another screen. However, the system is not aware of the position of the acetate sheet itself in relation to the primary projection display. Thus, moving the sheet of acetate does not change how the projection occurs. In other words, while moving the acetate sheet may change the information that is displayed on the sheet, the same information is displayed on the sheet no matter where the sheet is moved relative to the projection display. This means that moving the acetate sheet further away from or closer to the projector, or skewing it relative to the primary projection display will not change the content displayed on the acetate sheet.

Another type of system for an interactive exploration of volumetric data using a tangible screen is called a volume slicing display system. This type of system uses a projector and a single passive display (such as a piece of PLEXIGLAS® (a registered trademark of Atoglas Company in Philadelphia, Pa.) or paper). The projector projects a corresponding slice of a three-dimensional (3D) virtual object on the passive display in real time. By moving the passive display a “computed perspective” can be displayed to allow the user or users to feel as if 3D virtual objects co-exist in real space and to explore them interactively. However, only a single display is used and the information is not “anchored” to any other information. The system is just a stand alone projector that is shining some information up onto a single screen that is moved back and forth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the reconfigurable multiple-plane computer display system and method incorporate at least two computer displays that move relative to each other and are anchored in the same data space. At least one of the displays is movable relative to the other displays in the system. Some displays may be movable displays, each of the displays may be movable displays, and some displays may be fixed display, but at least one display can move with respect to the other displays.

In addition, the displays are anchored to each other in data space, meaning that each display shows interesting data that is complimentary to information being displayed on the other displays. “Complimentary” means that the information is somehow tied or related to the information being displayed on the other displays. The information displayed on the displays is grounded in the same reality of the other displays. This may be a 3D physical space or some other data landscape.

In some embodiments of the reconfigurable multiple-plane computer display system and method the data is anchored in a 3D physical space, such as an upright view of a building. By moving a movable display in space a user can indicate the desire to view the front of the building, or the back of the building, or some other slice of the building. This is indicated by simply moving the movable display around the 3D physical space.

Embodiments of the system and method include displays that may be active or passive. An active display is a display that actively displays information on its own, such as an LCD display or a CRT display. A passive display is a display that has no way of displaying information on its own. In addition, a display may include at least one processor and a positioning device. A display equipped with a processor and a positioning device is able to sense their location in the 3D physical space and know which data to display based on that location.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the reconfigurable multiple-plane computer display system and method implemented in a computing environment.

FIG. 2 is a flow diagram illustrating the general operation of embodiments of the reconfigurable multiple-plane computer display system shown in FIG. 1.

FIG. 3 is a block diagram illustrating a first embodiment of the reconfigurable multiple-plane computer display system and method having at least one fixed display.

FIG. 4 is a block diagram illustrating a second embodiment of the reconfigurable multiple-plane computer display system and method where each of the displays is movable.

FIG. 5 illustrates an example of a suitable computing system environment in which embodiments of the reconfigurable multiple-plane computer display system and method shown in FIGS. 1-4 may be implemented.

### DETAILED DESCRIPTION

In the following description of embodiments of the reconfigurable multiple-plane computer display system and method reference is made to the accompanying drawings, which form a part thereof, and in which is shown by way of illustration a specific example whereby embodiments of the reconfigurable multiple-plane computer display system and method may be practiced. It is to be understood that other embodiments may be utilized and structural changes may be made without departing from the scope of the claimed subject matter.

### I. System Overview

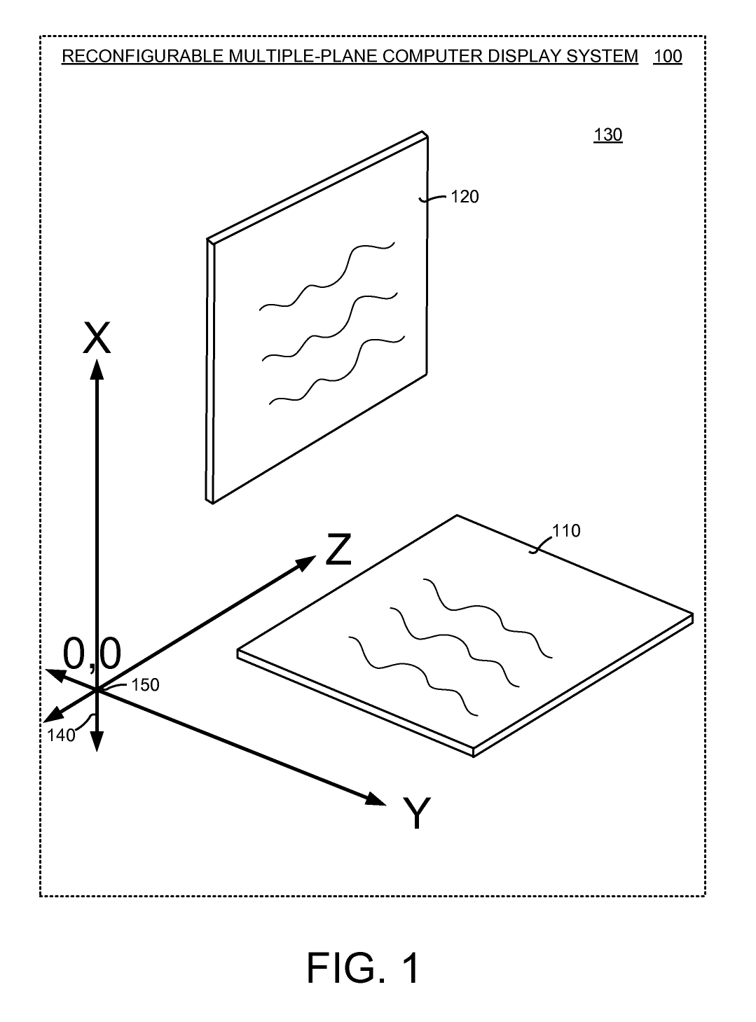

FIG. 1 is a block diagram illustrating a general overview of embodiments of the reconfigurable multiple-plane computer display system 100 and method implemented in a computing environment. In general, embodiments of the system 100 include a first display 110 and a second display 120. The first display 110 and the second display are located in a three-dimensional (3D) physical volume space 130. The squiggly lines shown on the first display 110 and on the second display 120 are meant to indicate that information or data is being displayed by those two displays.

The 3D physical volume space 130 can be defined using a 3D coordinate system. This coordinate system can be virtually any one of the numerous available 3D coordinate systems, such as a rectangular coordinate system, a cylindrical coordinate system, or a spherical coordinate system. FIG. 1 illustrates a 3D Cartesian coordinate system 140 having an X-axis, a Y-axis, and a Z-axis that are perpendicular to each other. The point at which each of the axes meet is denoted as point (0,0,0) 150. It should be noted that the 3D Cartesian coordinate system 140 is used in FIG. 1 for convenience and that any other suitable 3D coordinate system may be used to define the 3D physical volume space 130.

The first display 110 and the second display 120 can be either a movable display or a fixed display. A fixed display means that the display remains fixed in the 3D physical volume space, while a movable display means that the display can be moved within the space. Each of the embodiments of the reconfigurable multiple-plane computer display system 100 has at least one display that is a movable display. The movable display within the 3D physical volume space 130 relative to the other displays in the system 100. In other words, embodiments of the reconfigurable multiple-plane computer display system 100 contain at least two displays that are fundamentally mobile relative to each other. This relative mobility may be achieved by having one of the displays movable or each of the displays movable.

If a display is movable, it can be moved along one or more of the planes and in some embodiments may be rotated about one or more of the axes shown in FIG. 1. In addition, the size of the first display 110 and the second display 120 does not matter and is typically limited by technology. Moreover, the size of the first display 110 and the second display 120 relative to each other does not matter. For example, in some embodiments the displays may be the same size while in other embodiments one display may be larger that the other without affecting the performance of embodiments of the system 100 and method. The first display 110 and the second display 120 shown in FIG. 1 are shown as virtually the same size merely for ease of explaining embodiments of the reconfigurable multiple-plane computer display system 100 and method.

The first display and the second display also may be either passive or active displays. A passive display is a display that has no way of displaying information on its own. For example, a piece of plastic that is projected upon by a projector is a passive screen. An active display is a display that actively displays information on its own, such as an LCD display or a CRT display. A display may also include at least one processor. Active displays that include a processor may be a smartphone or some other type handheld computing device.

The processor in the active display can be used to help the display compute its location in the 3D physical volume space 130, where the display is in relation to another display in the system 100, and what information to show on the display based on the position of the display, another display, or both. The display may also include a location system that enables the device to find its location in the 3D physical volume space 130. Examples of a location system include dead reckoning, computer vision, digital gyroscope, digital compass, barometer, GPS, accelerometer, magnetic, beacon triangulation (Wi-Fi or cell towers), and a pedometer.

Embodiments of the reconfigurable multiple-plane computer display system 100 also include the first display 110 and the second display 120 that are anchored to each other in data space. Many existing systems use a stand-alone projector that shines information up on another screen. However, the information is not “anchored” to any other information in the world. Embodiments of the reconfigurable multiple-plane computer display system 100 include a first display 110 and a second display 120 that display information on each of the displays that is relative and anchored to each of the displays.

This idea of being anchored in data space is also known as “computed perspective.” The first display 110 provides reference points for where the information shown on the second display 120 is obtained. Thus, the computed perspective means that a display in embodiments of the reconfigurable multiple-plane computer display system 100 is anchored in data space relative to other displays in the system 100.

By way of example, the information displayed by the first display 110 is anchored to the information displayed by the second display 120, and vice versa. This computed perspective means that multiple displays are displaying data that is relative to their position with each other and that the information being shown on the displays is anchored in the same data space.

### II. Operational Overview

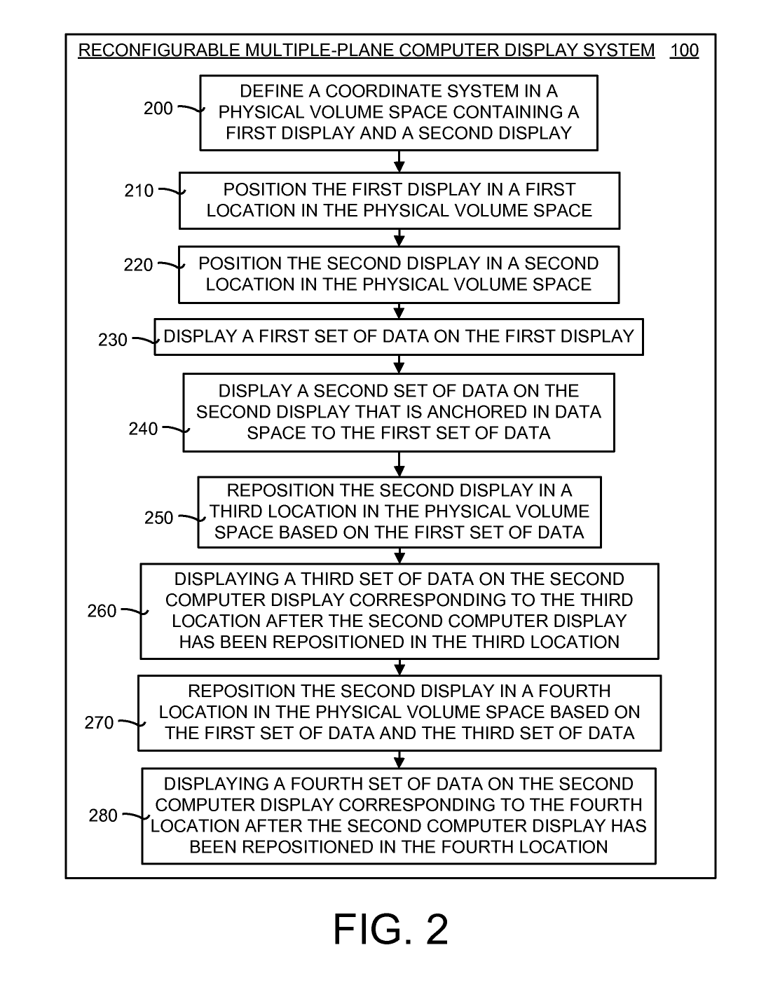

FIG. 2 is a flow diagram illustrating the general operation of embodiments of the reconfigurable multiple-plane computer display system 100 shown in FIG. 1. The operation of embodiments of the system 100 and method begins by defining a coordinate system in a physical volume space 130 that includes the first display 110 and the second display 120 (box 200). This coordinate system ties the multiple displays in the system 100 together in the physical volume space 130 so that the displays know which data to display based on the position in the physical volume space 130 of the displays in relation to each other.

Next, the first display 110 is positioned in at a first location in the physical volume space 130 (box 210). Similarly, the second display 120 is positioned in a second location (that is different from the first location) in the physical volume space 130 (box 220).

A first set of data then is displayed on the first display 110 (box 230). In addition, a second set of data is displayed on the second display 120 (box 240). The second set of data is anchored in data space to the first set of data. This means that the first set of data is related and dependent in some manner on the second set of data and vice versa. Moreover, the first set of data and the second set of data are related by the relative position of the displays on which that data is displayed.

For example, assume that the first display 110 is a fixed display and the first set of data is a floor plan of a building. Further, assume that the second display 120 is a movable display and that the second set of data is a cutaway view of the building in a plane that is perpendicular to the floor plan. The second set of data is anchored in data space because it is related and dependent on the first set of data. Moreover, the second set of data is dependent on the location of the second display 120 relative to the first display. If the second display 120 is positioned at where the outside wall of the building would be, then the second set of data displayed on the second display 120 would be the outside wall of the building. However, if the second display 120 is repositioned at a location corresponding to a location interior the building, the second set of data displayed on the second display may be a cutaway view of the elevator shaft.

Embodiments of the method then reposition the second display 120 in a third location in the physical volume space 130 (box 250). This repositioning is based on the first set of data. For example, a user may be looking at the first set of data displayed on the first display 110 and reposition the second display 120 based on the first set of data that the user is viewing by looking at the first display 110. In addition, based on its new location, the second computer display displays a third set of data that corresponds to the third location after the second computer display has been repositioned in the third position (box 260).

The second display 120 may be repositioned in a fourth location in the physical volume space 130 based on the first set of data and the third set of data (box 270). For example, the user may reposition one or more of the displays based on the data that the user is viewing on the first display 110 and the second display 120. Moreover, based on its new location, the second computer display displays a fourth set of data that corresponds to the fourth location after the second computer display has been repositioned in the fourth position (box 280).

### III. Details of Various Embodiments

Embodiments of the reconfigurable multiple-plane computer display system 100 and method can be implemented in a wide variety of embodiments that include at least two displays. These embodiments in include embodiments having at least one fixed display (and at least one movable display) and embodiments where each of the displays is movable. Given these constraints, each of these displays can be any combination passive and active displays as well as displays having their own processing power and their own location tracking capability. Each of these embodiments will now be discussed.

### III.A. Embodiments Having at Least One Fixed Display

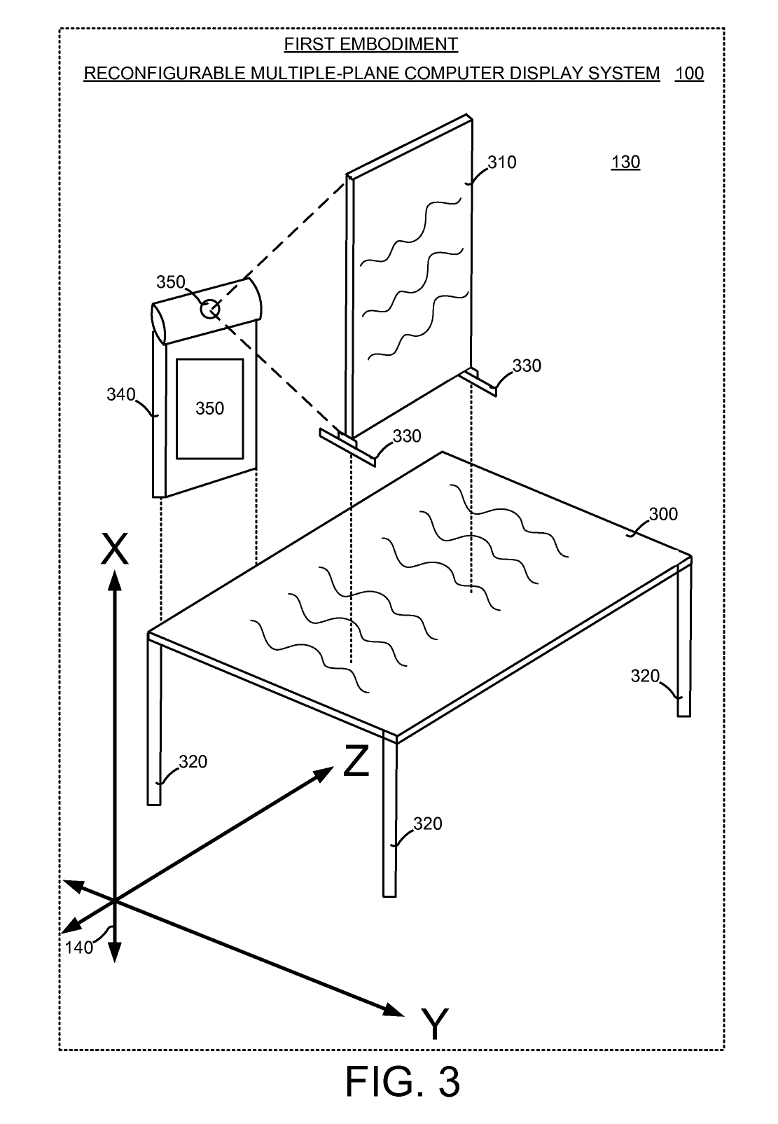

In some embodiments of the reconfigurable multiple-plane computer display system 100 at least one of the displays is fixed. Since embodiments of the reconfigurable multiple-plane computer display system 100 contain at least two displays, this means that at least one of the displays is movable. FIG. 3 is a block diagram illustrating a first embodiment of the reconfigurable multiple-plane computer display system 100 and method having at least one fixed display. In general, this embodiment has a fixed display 300 and a movable display 310. It should be noted that although only a single movable display 310 is shown, in some embodiments the system 100 includes a plurality of movable displays along with the fixed display 300.

The movable display 310 moves relative to the fixed display 300 within the 3D physical volume space 130. In some embodiments the 3D physical volume space is described by the 3D Cartesian coordinate system 140 having an X-axis, a Y-axis, and a Z-axis that are perpendicular to each other. The fixed display 300 is located on legs 320 and can either be an active display or a passive display. An example of an active display is an LCD display fixed in the Y-Z plane. In other embodiments the fixed display 300 is a passive display that is projected upon by a projection device (not shown) under the fixed display 300.

The movable display 310 is either an active display or a passive display. As shown in FIG. 3, the movable display 310 is a passive display, such as a sheet of acetate. The movable display 310 includes supports 330 to hold the movable display 310 upright. A computing device 340 containing a projector 350 is aimed at the passive movable display 310 to display data. In some embodiments, the fixed display 300 displays data of a perspective of a person, place, or object being displayed, and typically this data is not changing. However, typically the data displayed on the movable display 310 does change based on its position.

The fixed display 300 provides reference points and embodiments of a computed perspective module 360 contained on the computing device 340 compute the position of the movable display 310 in the 3D physical volume space 130. It should be noted that in some embodiments of the computed perspective module 360 it may be located on other computing devices other that the computing device 340.

In addition, embodiments of the computed perspective module 360 determine the data that is displayed on the movable display 310. The position of the movable display 310 dictates which data is displayed thereon. Thus, the data shown on the movable display 310 is anchored with respect to a single 3D model, where the data shown by the fixed display 300 is not changing but the data shown by the movable display 310 is changing whenever the movable display 310 is moved.

By way of example, embodiments of the reconfigurable multiple-plane computer display system 100 shown in FIG. 3 may be displaying a 3D model of a building. On the fixed display 300 may be shown a floor plan of a particular floor in the building (such as the second floor). The movable display 310 may show an elevation view of the building depending on where the movable display 310 is located in space. Referring to FIG. 3, if the movable display 310 is moved along the Y-axis then the elevation view shown will change depending on where the movable display 310 is located along the Y-axis. The floor plan shown on the fixed display 300, however, will not change in these embodiments.

In these embodiment the movable display 310 may also be rotated about the Z-axis. For example, imagine that the movable display 310 has been rotated 45 degrees about the Z-axis. Rotating the movable display 310 shows different information on the movable display 310 that is exactly in alignment and in relation to the static floor plan shown on the fixed display 300. It should be noted that the data displayed on the fixed display 300 and the movable display 310 does not have to be 3D model rendering (such as a floor plan). The data displayed on both displays 300, 310 can be related to each other differently than 3D model rendering.

In some embodiments of the system 100 and method the movable display 310 includes at least one processor. This processor, coupled with a positioning device, allows the movable display 310 to know where it is in the 3D physical volume space 130. For example, referring to FIG. 3, if a user turns the movable display 310 horizontal to the fixed display, then in some embodiments the movable display 310 could show different floor plans based on the elevation of the movable display 310 above the fixed display 300. The processor helps the movable display 310 know where it is in relation to the fixed display 300, and thus what information to display on the movable display 310.

Embodiments of the computed perspective module 360 compute where the movable display 310 is in the physical volume space 130. Typically, this position or location is described using the 3D Cartesian coordinate system 140. In some embodiments of the computed perspective module 360, a computer vision system (not shown) uses a camera and software to find the location of the movable display 310 at any point in time. In this manner embodiments of the computed perspective module 360 are able to “see” where the movable display 310 is relative to the fixed display 300. Other embodiments of the computed perspective module 360 can find the location of the movable display 310 using systems other that a computer vision system, such as dead reckoning, digital gyroscope, digital compass, barometer, GPS, accelerometer, magnetic, beacon triangulation (Wi-Fi or cell towers), and pedometer.

It should be noted that in some embodiments of the reconfigurable multiple-plane computer display system 100 and method the movable display 310 is moved repositioned manually. In other embodiments, the movable display 310 can be repositioned automatically. In these embodiments, embodiments of the computed perspective module 360 send coordinates of the new position to an automatic controller (not shown) that then automatically moves the movable display 310 to the desired spatial location in the 3D physical volume space 130.

### III.B. Embodiments Having All Movable Displays

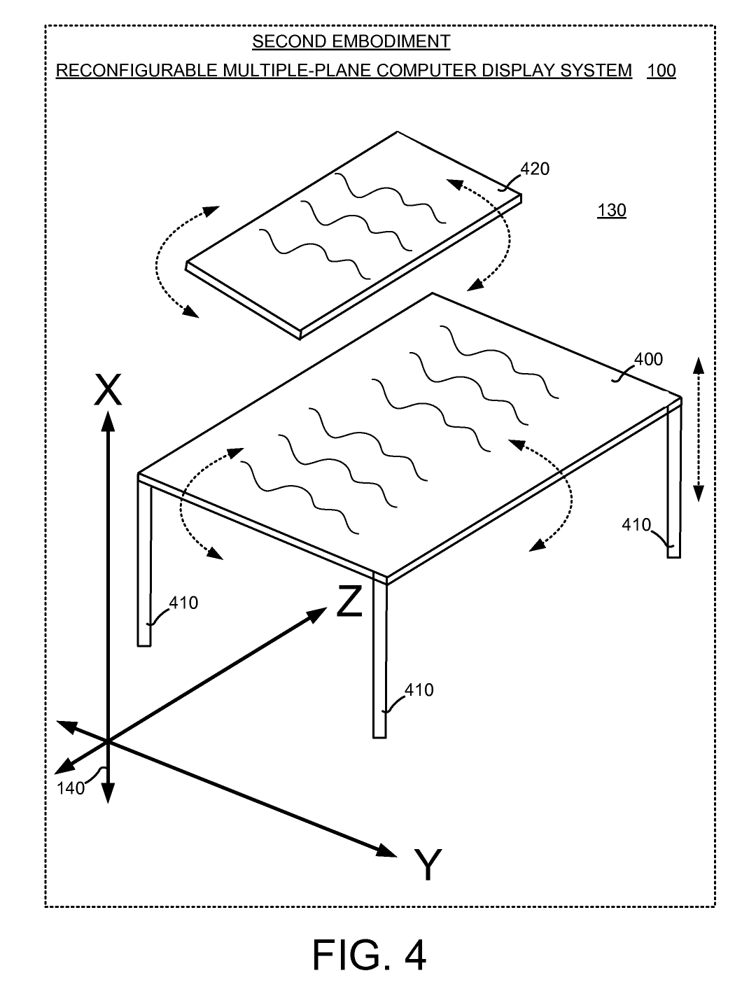

In some embodiments of the reconfigurable multiple-plane computer display system 100 and method each of the displays is movable. FIG. 4 is a block diagram illustrating a second embodiment of the reconfigurable multiple-plane computer display system 100 and method where each of the displays is movable. Note that the fixed display shown in FIG. 3 has now been made movable such that each of the displays is movable. Specifically, a first movable display 400 is movable along the X-axis. One way in which this can be facilitated is by having adjustable legs 410 supporting the first movable display 400. As noted above, the movement can be facilitating either manually or automatically.

Embodiments of the system 100 and method also include at least a second movable display 420. The first movable display 400 and the second movable display 420 are movable in six degrees of freedom in the 3D Cartesian coordinate system 140. In other embodiments, the system 100 and method include a plurality (more than two) of movable displays.

Using the building floor plan example from above, by moving the first movable display up or down different floors of the building would be displayed on the first movable display 400 dependent on the position of the first movable display 400 in the 3D physical volume space 130. For example, at a certain height the first movable display 400 may show the floor plan of the first floor. When the first movable display 400 is moved higher, at some height the first movable display 400 will show the floor plan of the second floor of the building. It should be noted that this height can be to scale. The second movable display 420 is used in the same manner as described above for the movable display 310 in FIG. 3.

### III.C. Other Embodiments

Other embodiments of the reconfigurable multiple-plane computer display system 100 and method include N number of movable displays (where N>2) and no fixed displays. In still other embodiments, the system 100 and method include M number of fixed displays and N number of movable displays. In these embodiments the displays may be passive or active, and may or may not have their own processing capabilities.

In some embodiments, the system 100 and method include movable active displays having their own processing capability. As an example of how these embodiments of the system 100 and method could work, assume that a group of students each has an active display (such as a tablet PC) and is looking at a virtual elephant that is only present on each display. A primary display would display the elephant, while each student's tablet PC would, depending on where the student was standing, displays a different part of the elephant. In other words, the part of the elephant displayed on the student's display would depend on its location, and corresponds to the part of the elephant where the display is located. This means that each of the plurality of movable displays is grounded in the same coordinate system and has a fixed perspective relative to each other.

Not each embodiment uses 3D models and is anchored in the same physical space. In these embodiments the displays will be grounded or anchored in the same data space. For example, some embodiments display a telephone book on a fixed display that is showing names, telephone numbers, and addresses. If a user looks only at the fixed display he will see only names, telephone numbers, and addresses. If, however, the user employs a movable display and sets it on top of the line named “Joe” he will see a picture of Joe on the movable display. Moreover, if the user turns the movable display in a different spatial orientation over the name “Joe” on the fixed display different information will be displayed to the user. Thus, even though the fixed and the movable displays are not grounded in a physical space with respect to one another they are still grounded in the data space.

### IV. Exemplary Operating Environment

Embodiments of the reconfigurable multiple-plane computer display system 100 and method are designed to operate in a computing environment. The following discussion is intended to provide a brief, general description of a suitable computing environment in which embodiments of the reconfigurable multiple-plane computer display system 100 and method may be implemented.

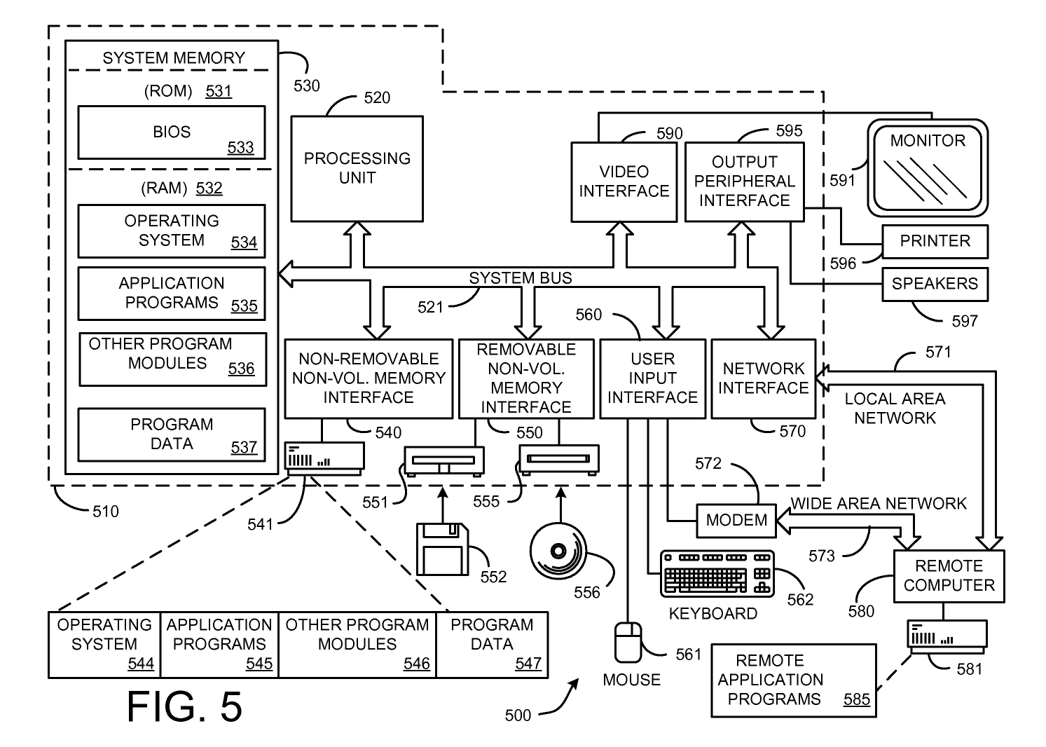

FIG. 5 illustrates an example of a suitable computing system environment in which embodiments of the reconfigurable multiple-plane computer display system 100 and method shown in FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment.

Embodiments of the reconfigurable multiple-plane computer display system 100 and method are operational with numerous other general purpose or special purpose computing system environments or configurations. Examples of well known computing systems, environments, and/or configurations that may be suitable for use with embodiments of the reconfigurable multiple-plane computer display system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the reconfigurable multiple-plane computer display system 100 and method may be described in the general context of computer-executable instructions, such as program modules, being executed by a computer. Generally, program modules include routines, programs, objects, components, data structures, and so forth, which perform particular tasks or implement particular abstract data types. Embodiments of the reconfigurable multiple-plane computer display system 100 and method may also be practiced in distributed computing environments where tasks are performed by remote processing devices that are linked through a communications network. In a distributed computing environment, program modules may be located in both local and remote computer storage media including memory storage devices. With reference to FIG. 5, an exemplary system for embodiments of the reconfigurable multiple-plane computer display system 100 and method includes a general-purpose computing device in the form of a computer 510.

Components of the computer 510 may include, but are not limited to, a processing unit 520 (such as a central processing unit, CPU), a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer readable media. Computer readable media can be any available media that can be accessed by the computer 510 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 510. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within the computer 510, such as during start-up, is typically stored in ROM 531. RAM 532 typically includes data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information (or data) into the computer 510 through input devices such as a keyboard 562, pointing device 561, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 520 through a user input interface 560 that is coupled to the system bus 521, but may be connected by other interface and bus structures, such as, for example, a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A reconfigurable multiple-plane display system, comprising a first computer display and a second computer display that move relative to each other and are anchored with respect to each other in a data space.

2. The reconfigurable multiple-plane display system of claim 1 further comprising moving the first computer display relative to the second computer display while the first computer display is fixed.

3. The reconfigurable multiple-plane display system of claim 1 further comprising moving both the first computer display and the second computer display relative to each other.

4. The reconfigurable multiple-plane display system of claim 1 further comprising having the first computer display be a passive display that is projected upon and has no way of displaying information on its own and the second display be an active display that actively displays information on its own.

5. The reconfigurable multiple-plane display system of claim 1 further comprising having the first display and the second display be active displays that actively display information on their own.

6. The reconfigurable multiple-plane display system of claim 1 further comprising having the first display and second display be passive displays that are projected upon and have no way of displaying information on their own.

7. The reconfigurable multiple-plane display system of claim 1 further comprising having the first display and second display be passive displays that are projected upon and have no way of displaying information on their own.

8. The reconfigurable multiple-plane display system of claim 1 further comprising:
a first processor contained in the first display, which is an active display; and
a second processor contained in the second display, which is an active display.

9. The reconfigurable multiple-plane display system of claim 8 further comprising:
a first location system contained in the first display such that the first location system can find a location of the first display in a physical volume space; and
a second location system contained in the second display such that second location system can find a location of the second display in the physical volume space.

10. A method for reconfiguring computer displays with respect to each other, comprising:
positioning a first computer display in a first location in a physical volume space;
positioning a second computer display in a second location in the physical volume space;
displaying a first set of data on a first computer display that is located in a physical volume space; and
repositioning the second display in a third location in the physical volume space based on the first set of data.

11. The method of claim 10, further comprising:
defining a coordinate system in the physical volume space that includes both the first computer display and the second computer display; and
positioning the first computer display and the second computer display using the coordinate system.

12. The method of claim 10, further comprising displaying a second set of data on the second computer display that is anchored in data space to the first set of data such that the first set of data is related and dependent on the second set of data and vice versa.

13. The method of claim 12, further comprising displaying a third set of data on the second computer display corresponding to the third location after the second computer display has been repositioned in the third location.

14. The method of claim 13, further comprising anchoring in data space the third set of data to the first set of data such that the first set of data is related and dependent on the third set of data and vice versa.

15. The method of claim 14, further comprising repositioning the second display in a fourth location in the physical volume space based on the first set of data and the third set of data.

16. The method of claim 15, further comprising displaying a fourth set of data on the second computer display corresponding to the fourth location after the second computer display has been repositioned in the fourth location.

17. The method of claim 16, further comprising anchoring in data space the fourth set of data to the first set of data such that the first set of data is related and dependent on the fourth set of data and vice versa.

18. A reconfigurable multiple-plane computer display system, comprising:
a plurality of fixed computer displays positioned in a three-dimensional physical volume space;
a first computer display from the plurality of fixed computer displays positioned at a first position in the three-dimensional physical volume space;
a plurality of movable computer displays positioned in the three-dimensional physical volume space;
a second computer display from the plurality of movable computer displays positioned at a second position in the three-dimensional physical volume space that moves relative to the first computer display;
a first set of data displayed on the first computer display that is dependent on the first position; and
a second set of data displayed on the second computer display that is dependent on the second position and the first set of data and the second set of data being anchored in the same data space.

19. The reconfigurable multiple-plane computer display system of claim 18 further comprising a third set of data displayed on the second computer display corresponding to a third position in the three-dimensional physical volume space that is dependent on the third position and displays information associated with the third position.

20. The reconfigurable multiple-plane computer display system of claim 19 further comprising a fourth set of data displayed on the second computer display corresponding to a fourth position in the three-dimensional physical volume space that is dependent on the fourth position and displays information associated with the fourth position.
